(19) United States
(12) Patent Application Publication
(10) Pub. No.: US 2026/0163852 A1
(43) Pub. Date: Jun. 11, 2026

(54) COMMUNICATION NETWORK SELECTION OF MODALITIES FOR TRANSMISSION OF COMMUNICATIONS TO RECIPIENTS WITH URGENCY INDICATIONS

(71) Applicant: AT&T Intellectual Property I, L.P., Atlanta, GA (US)

(72) Inventors: Sheldon Kent Meredith, Roswell, GA (US); Richard Oros, Canton, GA (US)

(21) Appl. No.: 18/974,753

(22) Filed: Dec. 9, 2024

(51) Int. Cl. H04L 51/066; H04L 51/56

(52) U.S. Cl. CPC H04L 51/066; H04L 51/56

(57) ABSTRACT

A processing system deployed in a communication network may obtain a communication in a first modality from a sender device to a destination device, where the first modality is one of: a voice communication or a text message. The processing may next detect a sender device context, the sender device context comprising a location of the sender device. In addition, the processing system may determine a recipient context associated with a recipient of the destination device, the recipient context comprising an unavailability of the recipient via the destination device. The processing system may further select a second modality for a delivery of the communication to the recipient, where the second modality is different from the first modality and where the selecting is based upon the sender device context and the recipient context. The processing system may then transmit the communication to the recipient in accordance with the second modality.

The present disclosure relates generally to multi-access technologies and cellular offloading, and more specifically to methods, computer-readable media, and apparatuses for transmitting a communication obtained in a first modality from a sender device to a recipient device in accordance with a second modality selected based upon a sender device context and a recipient content.

### BACKGROUND

Endpoint devices may be equipped with dual/multiple access technologies, e.g., cellular and non-cellular wireless access technologies. However, the user is generally responsible to choose between a cellular radio access network (RAN) or a non-cellular wireless access network (e.g., IEEE 802.11/Wi-Fi, etc.). In addition, endpoint devices may be equipped with software or hardware functionality to temporarily prevent delivery of text and/or voice messages, or to prevent ringing of the endpoint device for incoming calls (e.g., a do not disturb function). Likewise users may turn endpoint devices off, or may place endpoint devices in an airplane mode, e.g., where a device's cellular radio(s) are turned off/disabled.

### SUMMARY

In one example, the present disclosure describes a method, computer-readable medium, and apparatus for transmitting a communication obtained in a first modality from a sender device to a recipient in accordance with a second modality selected based upon a sender device context and a recipient content. For instance, in one example, a processing system including at least one processor deployed in a communication network may obtain a communication in a first modality from a sender device to a destination device, where the first modality is one of: a voice communication or a text message. The processing may next detect a sender device context, the sender device context comprising a location of the sender device. In addition, the processing system may determine a recipient context associated with a recipient of the destination device, the recipient context comprising an unavailability of the recipient via the destination device. The processing system may further select a second modality for a delivery of the communication to the recipient, where the second modality is different from the first modality and where the selecting is based upon the sender device context and the recipient context. The processing system may then transmit the communication to the recipient in accordance with the second modality.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates a flowchart of an example method for transmitting a communication obtained in a first modality from a sender device to a recipient device in accordance with a second modality selected based upon a sender device context and a recipient content; and

FIG. 3 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatuses for transmitting a communication obtained in a first modality from a sender device to a recipient device in accordance with a second modality selected based upon a sender device context and a recipient content. In particular, examples of the present disclosure describe a communications core-network functionality, e.g., a context-aware communication modality translation and selection system, that monitors voice and data communications on behalf of senders/callers, recipients/callees, or both. Information about these communications such as the sender, the sender device location, and the type of communication may be collected by a network function deployed in the communication network that distributes the communications and/or notifications thereof to recipient devices. The information about incoming communications can be enhanced using an analysis of text or natural language processing of a call that gets routed to a voice mail. For instance, the network function may determine an urgency level and/or an emergency scenario from the communication content and/or other contextual information, such as sender device location, presence of others or other devices near the sender device, a relationship of the sender and recipient, and so forth. In one example, when a recipient is unavailable at the destination device via the original communication modality of the communication (e.g., voice call, video call, text, or the like), the network function may determine whether to reach the recipient using an alternative communication modality, e.g., in consideration of the sender context, such as the urgency or existence of an emergency scenario, the recipient context, or both. In one example, the network function may further determine whether to reach the recipient at an alternative endpoint device associated with the recipient.

To illustrate, if the urgency level is deemed to be “medium” and the recipient fails to answer a ringing voice call at the recipient's mobile phone, the network function may select to transmit a text-based message containing the content of a voice message left for the recipient, e.g., via an over-the-top messaging application. For instance, the communication network may pass the communication or a notification thereof to a third-party server associated with the over-the-top messaging application. One or more data communications may then be transmitted to one or more endpoint devices associated with the recipient containing the contents of the voice message, a text content automatically generated from the voice message, and/or a notification of the call from the sender. Since the data communication(s) are from the third-party server, the communication(s) may be transmitted to an alternative device associated with the recipient, such as a personal computer, a tablet computing device, etc. where the recipient is logged-in to over-the-top messaging application, or the like. Thus, for example, the recipient may be ignoring calls or the recipient's mobile phone may be in a do-not-disturb mode, e.g., because the recipient is on a work-related online conference call, is in a meeting, is at a theater, etc. However, if the recipient is participating in an online conference via the recipient's personal computer, the recipient may receive a notification on the screen of a missed communication (e.g., a phone call) from the sender to the recipient's mobile phone.

In one example, if an urgency level is deemed to be “high,” the network function may select to override any do-not-disturb settings (e.g., including do-not-disturb settings, school time settings, theater mode settings, or the like) of the recipient's mobile phone. For instance, in a real or perceived emergency, rather than attempting a voice call, the sender may instead send one or more text messages (e.g., short message service (SMS) message(s)) to the recipient's mobile phone. However, the recipient may not be paying attention and may not see a notification of a text message. Thus, as an alternative or in addition to delivering the one or more text messages to the recipient's mobile phone, the network function may initiate a voice call to the recipient's mobile phone, which may cause the device to ring, and which may be more noticeable to the recipient. In addition, the network function may convert the text content of the one or more text messages to voice, and may transmit the audio content via the voice call for presentation to the recipient.

In one example, the urgency level can be included in the communication content for presentation to the recipient (e.g., as voice or text, depending on the communication modality in which the communication is ultimately delivered to the recipient via one or several endpoint devices). In one example, the urgency level can alternatively or additionally be included in the message/call metadata of the communication in order to ultimately modify the visual or audio presentation to the recipient in order to increase the likelihood of a reaction. For instance, in one example, the present disclosure may also include an enhanced functionality within mobile phones or other endpoint devices to override any do-not-disturb settings based upon indicated urgency levels. Alternatively, or in addition, this functionality may include user-configurable settings for urgency levels that may override the do-not-disturb settings and/or rule sets that may permit an override of any do-not-disturb settings based upon particular sender contexts, recipient contexts, and/or combinations thereof (e.g., in sender emergency scenarios, where the sender and recipient have a parent-child relationship, spouse-spouse relationship, or the like).

It should be noted that existing online collaboration and messaging applications (such as Microsoft Teams™, Slack™, etc.) may facilitate on-screen notifications of calls, messages, and meeting notifications. A user of such an application can have multiple associated devices that are logged in and/or that can otherwise receive notifications and/or communications via the application. Therefore, a user may have multiple screens via which the user can be simultaneously notified of incoming calls, messages, meetings, etc. However, this functionality ultimately requires a specific software application on each device, whether for the sender or the receiver of a communication. For instance, when a caller uses collaboration/messaging application #1 to call another person, the called party must also have collaboration/messaging application #1 to receive the call. Thus, each collaboration/messaging application may comprise a closed ecosystem, where all senders and receivers of communications must be part of the ecosystem by the fact of having a dedicated software application installed on each associated device.

Some mobile phones or other mobile/cellular devices may include operating system software that processes incoming text or phone calls, which do not have to originate from a particular collaboration/messaging application, and which may forward the communications and/or notifications thereof to a cloud-based infrastructure which relays the information to all other devices associated with a same user identifier (user ID). For example, a sender endpoint device may initiate a phone call or text message to a recipient endpoint device (e.g., a mobile phone) which receives the communication and sends a message to the cloud-based infrastructure, which is aware of other devices associated with the same user ID. The cloud-based infrastructure then forwards the call or text information to all of those associated devices. Therefore, a short time after the first endpoint device of the recipient receives the communication, other devices on the same user ID may also receive the same communication(s). Nevertheless, any computing device not having such an operating system and/or collaboration and messaging application cannot receive/display associated notifications when other parties are texting or calling. If a user is working on a computer and there is a message to the user's mobile phone (or perhaps the user's mobile phone is in a do-not-disturb or airplane mode) the user will not receive the communication or a notification thereof on the computer unless (1) the computer has an operating system with the associated user ID, or (2) the communication originated via a collaboration and messaging application of the sender and the user/recipient's computer also has the same collaboration and messaging application software.

In contrast, examples of the present disclosure enable voice calls and text messages that may be addressed to a recipient's endpoint device, e.g., a mobile phone or another device with an assigned telephone number or international mobile subscriber identity (IMSI), to be intelligently translated into other communication modalities. In one example, the present disclosure may also enable such communications to be further transmitted/notified to alternate endpoint devices associated with the recipient, without any specific operating system or collaboration and messaging application software being required on the original intended destination endpoint device (e.g., the recipient's endpoint device associated with the telephone number/IMSI). In addition, examples of the present disclosure may further provide notification to recipients and their endpoint devices about the urgency of the communications by analyzing the voice content of messages going to a voicemail system, using the content of text messages, and/or other contextual information, such as the sender device location, and so forth. In one example, urgency information may be used to provide sounds or visual effects at the receiver's endpoint device(s) to not only indicate the fact of an incoming communication, but also emphasize the urgency thereof.

To provide these and other aspects, the present disclosure may include a dedicated network function (NF) in a communication network (e.g., in a cellular core network) that is in a signaling path and/or which may obtain signaling messages for both voice call and text message/SMS traffic. When a communication to a recipient's endpoint device is initiated by a sender's endpoint device, one or more signaling message, one or more call detail records (CDRs), or the like, may be generated for call routing, paging, fraud analytics, etc. In accordance with the present disclosure, some or all of such information may be copied by other network functions, such as an access management function (AMF), a user plane function (UPF), a session management function (SMF), etc., and sent to the network function. The NF may also receive status information of the messaging, e.g., a voice call that was not connected but sent to voicemail, a voice call that rang through but that was not answered (e.g., and similarly that was sent to voicemail), a SMS message that was delivered but not read, etc.

The NF may use the telephone number (TN), e.g., an IMSI or the like, of the calling or texting party as well as the target TN/IMSI to obtain additional context of the sender, the recipient, or both, such as the sender device location, a relationship of the sender and the recipient, and so forth. For instance, some or all of this information may be stored in the communication network in a subscriber profile (e.g., in a unified data management (UDM) network function, or the like). Alternatively, or in addition, the NF may request this information from the sender device, the intended destination endpoint device of the recipient, and so forth.

In one example, the NF may also be in the calling path, user data path/data plane, or the like. Alternatively, or in addition, the call/message data contents may be copied to the NF from other NFs (e.g., with the consent of one or both parties, and on behalf of the one or both parties). As such, the NF may also extract context information from the communication contents. This can include indications of urgency such as, “Mike, this is Deborah, I just wrecked my car and I need you to call me back right now.” Certain keywords or phrases can also indicate urgency, which may be detected via artificial intelligence (AI) and/or machine learning (ML) tools to improve such detection over time. In one example, the NL may determine an urgency level associated with the communication based on the content analysis and/or using additional context information, such as sender device location, relationship of sender to recipient, etc. Similarly, when a call goes to voicemail, natural language processing can be used to convert audio into text, which can then be analyzed in the same manner as a text for the purpose of determining urgency.

The availability status of the recipient on the intended destination device as well as the sender and/or receiver context may be used to select whether to notify the recipient/receiver via a different communication modality (e.g., voice instead of text, via a third-party/OTT messaging application instead of cellular/3GPP voice and/or SMS messaging, etc.) and/or via a different endpoint device. In one example, the communication sent to the receiver's endpoint device(s) may be enhanced with information from additional databases, such as looking up a caller's name from a calling name database based on the caller's TN/IMSI. For instance, the NF may use the incoming TN/IMSI to dip a database and learn that it belongs to someone named Joe. The NF may then notify the recipient with an additional notification of “Incoming call from Joe with TN=abc-def-ghij,” which may be presented via one or more endpoint devices of the recipient. With proper authorizations, such as user opt-in, other enhancements may include the location of the sending device, e.g., latitude/longitude, venue name, and/or street address, etc. For instance, an enhanced notification might read . . . “Incoming call from Joe with TN=abc-def-ghij currently located near 123 Main Street of Town XYZ.”

Depending on the type of communication, the recipient may be enabled to answer/pick-up and/or respond via an alternative endpoint device of the recipient. However, in other cases, the destination endpoint device may be equipped to present a notification, where the recipient may still answer a call and/or obtain message contents via the original intended destination endpoint device. For example, for an unanswered voice call, the NF in the communication network may translate a voice message communication into a format for a 3^{rd} party/OTT messaging application (e.g., a text-format, an audio file format (e.g., .wav, .mp4, etc.), or the like), and may forward the communication to a cloud-based platform of the 3^{rd} party/OTT messaging application for onward transmission to one or more endpoint devices associated with the recipient, such as a personal computer. For example, the recipient may provide a user identifier (ID) associated with 3^{rd} party/OTT messaging application to the communication network, and may grant the communication network permission to initiate communications to the recipient via the user ID. Thus, for example, a cloud-based platform of the 3^{rd} party/OTT messaging application may provide an application programming interface (API) or the like for authorized entities, such as communication networks, banking and credit card institutions, etc. to direct communications to application users. As such, the 3^{rd} party/OTT messaging application on the personal computer may receive a text or audio-based communication from the NF in the communication network via the 3^{rd} party/OTT messaging application platform/server(s). In addition, the personal computer may present the notification, e.g., visually, audibly, and/or via haptics, but may not be equipped to connect a voice call to the sender/caller's mobile phone. Thus, the receiver of the notification may still be directed to answer on the receiver's mobile phone, or to initiate a call-back to the caller/sender via the receiver's mobile phone.

As noted above, an urgency level can be included in the information sent the 3^{rd} party/OTT messaging application platform/server(s), which can then be used to audibly or visually enhance the notification to the end user on all devices associated with the recipient, e.g., depending on the capabilities of the 3^{rd} party/OTT messaging application and/or the personal computer (or other endpoint devices of the recipient receiving the communication). In a similar example, the urgency level may also be sent to a mobile phone of the recipient, e.g., where the modality of the communication may be altered by the NF, and where it may be determined to override a do-not-disturb mode or the like. For instance, in cases of an urgency level being “high,” the communication contents (e.g., text converted to voice/audio or vice versa) may also be displayed/presented.

In one example, the NF operations may be split into two modules and/or two network functions, such as a first NF to determine that a recipient is unavailable and to determine the urgency of a communication, and a second NF to determine where to reach the recipient and to determine the communication modality (or modalities) to use to reach the recipient. In one example, the first or the second NF may also select additional context information to provide in order for the recipient's endpoint device(s) to determine how to handle the communication and/or for direct visual, audio, or other presentations to the recipient. In still another example, functionality of the second NF (e.g., determining how to reach the recipient) may be external to the communication network. For instance, as described above, the communication may be provided to a 3^{rd} party/OTT messaging application platform/server(s), which may determine parallel notifications to one or more computing devices associated with a user/account ID.

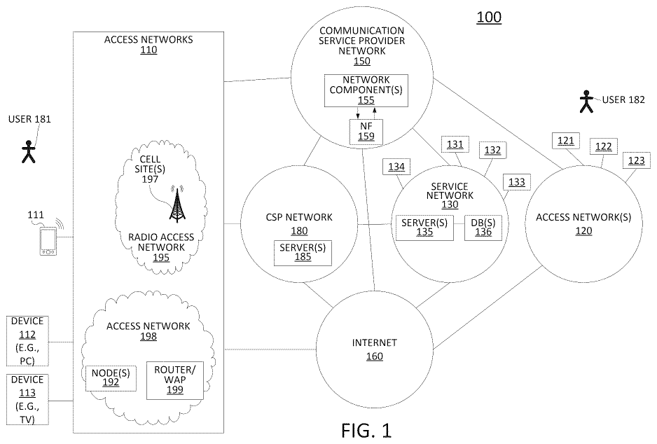

Thus, examples of the present disclosure enable users who are indisposed to answer calls, voicemail messages, or text contents during meetings or perhaps while driving to quickly hear or see notifications thereof and/or to be interrupted to receive the communication contents, which may include indications of urgency that may be visual, audible, or haptic. In some cases, this may allow a recipient to assess if the incoming communication is worthy of disrupting an activity otherwise indisposing the recipient. In other cases, e.g., of high urgency of the communication (such as emergency scenarios), the recipient may be automatically interrupted. These and other aspects of the present disclosure are discussed in greater detail below in connection with the examples of FIGS. 1-3.

To aid in understanding the present disclosure, FIG. 1 illustrates an example system 100 comprising a plurality of different networks in which examples of the present disclosure for may operate. Communication service provider network 150 may comprise a core network with components for telephone services, Internet services, and/or video services (e.g., triple-play services, etc.) that are provided to customers (broadly “subscribers”), and to peer networks. In one example, communication service provider network 150 may combine core network components of a cellular network with components of a triple-play service network. For example, communication service provider network 150 may functionally comprise a fixed-mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 150 may also further comprise a broadcast video network, e.g., a traditional cable provider network or an Internet Protocol Television (IPTV) network, as well as an Internet Service Provider (ISP) network. With respect to video service provider functions, communication service provider network 150 may include one or more video servers (e.g., television servers) for the delivery of video content, e.g., a broadcast server, a cable head-end, a video-on-demand (VoD) server, and so forth, which may be represented by some or all of network component(s) 155. For example, communication service provider network 150 may comprise a video super hub office, a video hub office and/or a service office/central office.

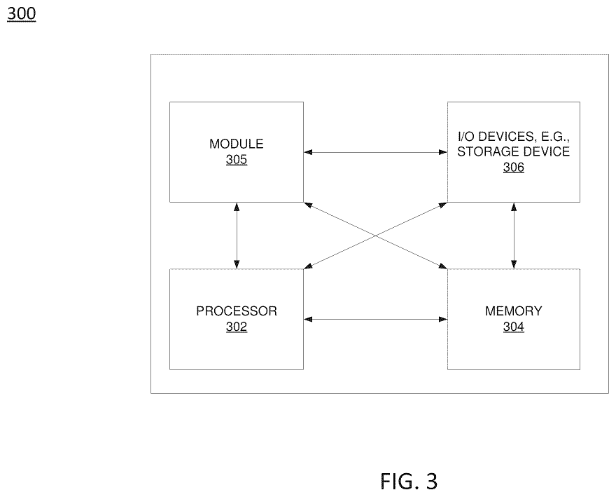

In one example, communication service provider network 150 may also include one or more network components 155. In one example, the network component(s) 155 may each comprise a computing system, such as computing system 300 depicted in FIG. 3, and may be configured to host one or more communication network components. For example, a first communication network component may comprise a database of assigned telephone numbers, a second communication network component may comprise a database of basic customer account information for all or a portion of the customers/subscribers of the communication service provider network 150, a third communication network component may comprise a cellular network service home location register (HLR), e.g., with current serving base station information of various subscribers, and so forth. Other communication network components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other communication network components may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner. For ease of illustration, various other components of communication service provider network 150 are omitted from FIG. 1.

In one example, various components of communication service provider network 150 comprise network function virtualization infrastructure (NFVI), e.g., software defined network (SDN) host devices (i.e., physical devices) configured to operate as various virtual network functions (VNFs), such as a Short Message Service (SMS) server, a voicemail server, a video-on-demand server, etc. For instance, network component(s) 155 may represent any one or more NFVI/SDN host devices configured to operate as any one or more of such VNFs. Similarly, in an example in which communication service provider network 150 may comprise a cellular core network (e.g., an evolved packet core (EPC), a 5G core or the like), network component(s) 155 may represent NFVI hosting one or more of a virtual access management function (AMF), a virtual session management function (SMF), a virtual user plane function (UPF), a virtual MME (vMME), a virtual HHS (vHSS), a virtual serving gateway (vSGW), a virtual packet data network gateway (vPGW), and so forth. Thus, for example, network component(s) 155 may comprise a vAMF, vSMF, a vUPF, a vMME, a vSGW, a virtual network slice selection function (NSSF), and so forth.

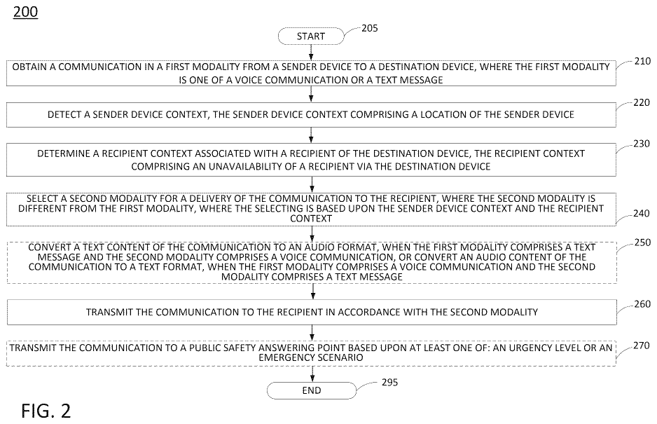

As illustrated in FIG. 1, communication service provider network 150 may further include a network function (NF) 159, e.g., a context-aware communication modality translation and selection system, which may comprise all or a portion of a computing device or system, such as computing system 300, and/or processing system 302 as described in connection with FIG. 3 below, specifically configured to perform various steps, functions, and/or operations for transmitting a communication obtained in a first modality from a sender device to a recipient in accordance with a second modality selected based upon a sender device context and a recipient content, e.g., in accordance with the example method 200 of FIG. 2, or as otherwise described herein.

In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

Access networks 110 and 120 may transmit and receive communications between devices 111-113 and devices 121-123 among one another and/or with service network 130, and between communication service provider network 150 and devices 111-113 and 121-123 relating to voice telephone calls, communications with web servers via the Internet 160, and so forth. Access networks 110 and 120 may also transmit and receive communications between devices 111-113, 121-123 and other networks and devices via Internet 160. Devices 111-113 may each comprise an endpoint device, e.g., a mobile/wireless endpoint device, such as a cellular smart phone or a cellular-capable laptop, tablet computer, smartwatch or the like, which may be equipped with a cellular radio unit and subscriber identity module (SIM), eSIM, or the like. Similarly devices 121-123 may each comprise an endpoint device, e.g., a mobile/wireless endpoint device, such as a cellular smart phone, a laptop, a tablet computer, etc. It should also be noted that in the example of FIG. 1, devices 112 and 113 may alternatively or additionally include one or more routers, gateways, servers (e.g., web servers, video and/or other content servers, conference servers, and so forth), desktop computers, a plurality or cluster of such devices, televisions (TVs), e.g., a “smart” TV, set-top boxes (STBs), or the like.

In one example, access networks 110 may include a cellular access network (e.g., radio access network 195), implementing such technologies as: 3^{rd} Generation Partnership Project (3GPP) 5G new radio (NR) and/or Long Term Evolution (LTE) access technologies, global system for mobile communication (GSM), e.g., a base station subsystem (BSS), GSM enhanced data rates for global evolution (EDGE) radio access network (GERAN), or a UMTS terrestrial radio access network (UTRAN) network, among others, where communication service provider network 150 may provide core network functions, e.g., of a public land mobile network (PLMN)-universal mobile telecommunications system (UMTS)/General Packet Radio Service (GPRS) core network, or the like. In this regard, radio access network 195 may include one or more cell sites 197, e.g., base stations, which may include antenna arrays, e.g., remote radio heads (RRHs), or radio units (RUs), base station equipment and/or one or more components thereof (e.g., a distributed unit (DU) and/or centralized unit (CU), etc.), transformers, battery units, and/or or other power equipment, and so forth. For instance, cell sites 197 may comprise one or more gNBs (or gNodeBs), eNodeBs, or the like.

In the example of FIG. 1, access networks 110 may also include a non-cellular access network 198, which may include a customer premises network (e.g., a local area network (LAN), a home network, an enterprise network, etc.) having at least one wireless access point (WAP) 199, e.g., a wireless router. For instance, WAP 199 may comprise an Institute for Electrical and Electronics Engineers (IEEE) 802.11 (Wi-Fi) router (in one example, WAP may further comprise a wired Ethernet router or the like, e.g., a dual wired/wireless router). In one example, wireless access network 198 may provide wide area network (WAN) connectivity via a Digital Subscriber Line (DSL) network, a broadband cable access network, a fiber-optic access network, or the like (broadly, an internet service provider ISP) network). For example, for a fiber-optic access network, the access network 198 may include node(s) 192, e.g., a mini-fiber node (MFN), a video-ready access device (VRAD), or the like. However, in another example, such an intermediate node may be omitted, e.g., for fiber-to-the-premises (FTTP) installations. Although access networks 110 include two example access networks as illustrated in FIG. 1, it should be understood that access networks 110 may include one or more additional non-cellular wireless access networks, one or more additional cellular access networks (e.g., RAN(s)), satellite access networks, and so forth. In one example, access networks 120 may include access networks of the same or similar types as access networks 110 (e.g., one or more non-cellular wireless access networks, one or more cellular access networks (e.g., RAN(s)), one or more satellite access networks, and so forth. In one example, one or more of the access networks 110 and 120 may be operated by the same or a different service provider from a service provider operating the communication service provider network 150.

In one example, access networks 110 and 120 may include customer premises networks, e.g., a home network or enterprise network, which may include a gateway to receive data associated with different types of media, e.g., television, phone, and Internet, and to separate these communications for the appropriate devices. For example, in access network 198, data communications, e.g., Internet Protocol (IP) based communications may be sent to and received from a router, e.g., WAP 199, which may receive data from and sends data to device 112 and/or device 113, respectively. In this regard, it should be noted that in some examples, device 112 and/or device 113 may connect to access network 198 via one or more intermediate devices, such as a gateway and router, while in another example, device 112 and/or device 113 may connect directly to access network 198, e.g., where access network 198 may comprise a local area networks (LAN), enterprise network, and/or home network, or the like. For instance, as described in greater detail below, in one example, device 112 may comprise a personal computer, while device 113 may comprise a television (TV).

In one example, system 100 may also include a cloud service provider (CSP) network 180 having one or more host devices, or nodes 185, which may each comprise networked computing resources for providing cloud services directly on behalf of CSP network 180 and/or for third parties having project development environments, data storage, and/or applications/services hosted via CSP network 180. For instance, node(s) 185 may comprise public or private cloud computing resources in one or more data centers, such as central processing units (CPUs), graphics processing units (GPUs), memory, storage devices, and so forth. The computing resources may operate as servers for hosting virtual machines, containers, microservices, or the like providing various applications (e.g., 3^{rd} party/OTT collaboration and/or messaging application platform(s), etc.), may operate as storage systems for storing databases, data tables, graphs, and so on. In one example, CSP network 180 may comprise a content distribution network (CDN) or at least a portion thereof. In various examples, CSP network 180 may be provided by a same entity as communication service provider network 150 or a different entity. It should also be noted that in one example, access networks 110 and/or 120 may comprise “edge clouds” which may similarly include host devices/nodes for providing cloud services such as mentioned above, but in locations that may be physically closer to various endpoint devices that may utilize such services.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the communication service provider network 150. For example, the service network 130 may comprise one or more devices for providing services to subscribers, customers, and/or users. For example, communication service provider network 150 may provide a cloud storage or other cloud computing services, web server hosting, and other services. As such, service network 130 may represent aspects of communication service provider network 150 where infrastructure for supporting such services may be deployed. In another example, service network 130 may provide network management (e.g., including outage monitoring, troubleshooting, remediation, etc.) as a service to various other entities. For instance, in a managed information technology (IT) scenario, a provider and consumer enter into an agreement for proactive monitoring and support for managed assets (broadly, network elements).

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the communication service provider network 150, devices 131-134 of the service network 130 may comprise devices of network personnel, such as network operations personnel and/or personnel for network maintenance, network repair, construction planning, customer service, and so forth.

In the example of FIG. 1, service network 130 may include one or more servers 135 which may each comprise all or a portion of a computing device or system, such as computing system 300, and/or processing system 302 as described in connection with FIG. 3 below, specifically configured to perform various steps, functions, and/or operations in connection with examples of the present disclosure for transmitting a communication obtained in a first modality from a sender device to a recipient in accordance with a second modality selected based upon a sender device context and a recipient content, such as described in connection with the example method 200 of FIG. 2, or as otherwise described herein. For instance, the one or more of the servers 135 may represent a conference server (e.g., for audio and/or online conferencing), a machine learning development platform, and so forth.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for transmitting a communication obtained in a first modality from a sender device to a recipient in accordance with a second modality selected based upon a sender device context and a recipient content, as described herein. As just one example, DB(s) 136 may further store recipient and/or sender do-not-disturb override preferences, training data/records for machine learning model training, as described in greater detail below, and so forth.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In this regard, server(s) 135 and/or DB(s) 136 may maintain communications with one or more of the devices 111-113 and/or devices 121-123, network component(s) 155, and so forth, via access networks 110 and 120, communication service provider network 150, Internet 160, and so forth, e.g., in order to collect, maintain, and/or update various records store therein..

As noted above, NF 159 in communication service provider network 150 may comprise a context-aware communication modality translation and selection system, e.g., a NF to perform various steps, functions, and/or operations for transmitting a communication obtained in a first modality from a sender device to a recipient in accordance with a second modality selected based upon a sender device context and a recipient content, e.g., in accordance with the example method 200 of FIG. 2. To illustrate, in one example, user 181 may opt-in to context-aware communication modality translation and selection service from communication service provider network 150, e.g., for urgent communications or the like. To further illustrate, a user 182 may initiate a communication to device 111, e.g., a mobile phone, of user 181. The communication may comprise a voice communication (e.g., a voice call or a voice message) or a text message (e.g., a SMS message). For instance, the communication may be addressed to device 111 from device 121 in accordance with a phone number (e.g., a TN and/or IMSI) associated with device 111. The communication may be received and processed via one or more network component(s) 155 of communication service provider network 150. The particular, network component(s) 155 may depend on the modality of the communication (e.g., voice call or text/SMS). For example, for a text message, the incoming message may be received via one or more SMS servers and may be forwarded to device 111 via a UPF and one of cell site(s) 197, and/or directly from an SMS server via one of cell site(s) 197. On the other hand, for a voice communication, an incoming call may be received and processed via one or more network component(s) 155 comprising a security gateway (SeGW) and/or a shared gateway, a UPF, etc., e.g., as the call is received from a peer cellular network, or the like.

In one example, NF 159 may be in a SMS processing path, e.g., in-line with one or more SMS servers, a UPF, and/or a base station. Alternatively, or in addition, NF 159 may be in a voice call path between a UPF and base station, for example. In another example, one or more of the network component(s) 155 may be configured to pass signaling messages, CDRs, or the like (or information extracted from these messages/records) to NF 159. In addition, one or more of such network component(s) 155 may be configured to receive and implement instructions from NF 159, e.g., to re-route a communication, to copy a communication for routing to additional endpoint devices associated with a recipient, to store communications, e.g., for delayed delivery or retrieval, etc. In one example, in accordance with the present disclosure, the NF 159 may also obtain contents of the communication, e.g., by virtue of being in the call/message path and/or by one or more network component(s) 155 copying the communication contents and forwarding the contents to NF 159.

In one example, the NF 159 may be configured to allow the communication service provider network 150 to attempt a delivery of the communication via the initial communication modality, e.g., to attempt delivery of a text/SMS message or a voice message, or to connect a phone call to the device 111. In one example, when a message/call is delivered/connected successfully, the NF 159 may take no further action. In another example, for a text/SMS that is delivered, or for a call that initially rings the device 111, NF 159 may continue to receive status information of the communication, e.g., a voice call that rings through but that is not answered (e.g., and that is similarly sent to voicemail), a SMS message that is delivered but that is not read, etc. In each case, the NF 159 may determine that the user 181 is not available via the first communication modality (e.g., text/SMS or voice communication, respectively). Alternatively, or in addition, in one example, NF 159 may determine that user 181 is unavailable via the first communication modality in a different way, such as: detecting from the signaling message(s), CDRs, or the like that the communication (e.g., comprising a voice call) is not connected, detecting that the device 111 is not attached to the radio access network 195 (or other RANs), e.g., not radio resource control (RRC) connected, or the like, such as due to the device 111 being off, in an airplane mode (and hence) not attached to a non-cellular wireless network or the like), etc. Alternatively, or in addition, device 111 may be configured to communicate a do-not-disturb status to NF 159.

In any of these cases, NF 159 may determine that the recipient, user 181, is unavailable via the first communication modality. In response, NF 159 may then determine a second communication modality via which to attempt to deliver the communication to the user 181. In accordance with the present disclosure, this may be based on a recipient context, which may include at least the unavailability of user 181 via the first communication modality on device 111. In one example, NF 159 may determine additional recipient context, such as more specific information as to why user 181 may be unavailable via the first communication modality on device 111 (e.g., whether a call rings through but is not answered versus a call that fails to ring, whether a text/SMS is undeliverable versus a text/SMS that is delivered but not read, etc., whether the device 111 is RRC connected, whether NF 159 is aware of a do-not-disturb status of device 111, whether device 111 may have a communication session established with any cellular core network functions via a non-cellular access network (e.g., device 111 may have network connectivity via access network 198), and so forth). For instance, the foregoing types of recipient context information may be determined by NF 159 from network component(s) 155, cell site(s) 197, and/or device 111 itself. Similarly, recipient context information may also include location information of device 111 (if available, such as when device 111 is RRC connected, or when device 111 has an alternate network connectivity and reports location to communication service provider network 150). For instance, a location may be determined from reported latitude and longitude, and/or from a cell site to which device 111 may be attached/RRC connected.

In one example, additional recipient context may alternatively or additionally be obtained from other devices associated with user 181, such as one or both of the devices 112 and 113. For instance, NF 159 may determine that user 181 is watching video program via device 113 (e.g., a television) when the user 181 may be logged in to a session with a video server (e.g., represented by network component(s) 115) via the device 113 (e.g., a smart TV) and/or a set-top box (STB) associated with device 113, or the like over access network 198. Alternatively, or in addition, NF 159 may determine that user 181 may be actively using device 112 (e.g., a PC) that is network-connected via access network 198. For instance, user 181 may be participating in an online conference hosted via server(s) 185 and may be logged-in with an account/user ID associated with an online collaboration and messaging platform represented by server(s) 185. In addition, in such an example, user 181 may have consented to have server(s) 185 indicate a presence of user 181 to communication service provider network 150/NF 159. Alternatively, or in addition, device 111 may also include an application associated with the online collaboration and messaging platform, which may determine that the user 181 is participating in an online meeting via device 112, and where device 111 may transmit a notification of the status/presence of user 181 to NF 159.

In one example, recipient context may further include communication preferences and/or permissions for user 181. For instance, user 181 may specify that communication service provider network 150 is permitted to override do-not-disturb settings for communications with a particular urgency level (or greater), at particular times of day, days of the week, etc., during particular events and/or event types, but not for others, at particular locations, or excluding certain locations, and so forth. In one example, the user preferences may be stored by and/or retrieved from network component(s) 155, e.g., a UDM network function, or the like and/or from server(s) 135 and/or DB(s) 136, depending upon the particular implementation and user preferences storage location. In another example, device 111 may provide such preference(s)/permission(s) upon request from NF 159.

NF 159 may use any or all of such recipient context to determine whether to deliver the communication to user 181 at the same device 111 via a different communication modality, and/or via a different device via a different communication modality (e.g., using a video/television program overlay via device 113 (e.g., a television) and/or by way of a message using a 3^{rd} party/OTT collaboration and messaging application via device 112 (e.g., a PC)). However, it should be noted that in one example, NF 159 may also use sender device context to also deduce the foregoing decision and actions. For instance, the sender context, or sender device context, may include the location of the user 182, e.g., the location of device 121. In one example, the sender device context may also include an urgency of the communication. In one example, the location may be a factor in determining the urgency of the communication. In another example, such data may be separate aspects of sender device context. In one example, the urgency may be based on an existence of an emergency situation. In one example, the sender device context may include a relationship of the sender, user 182, and the recipient, user 181. In one example, the sender device context may include a presence of other individuals/other devices around the user 182 and/or device 121. In one example, a determination of the urgency of the communication may be based upon the relationship of users 181 and 182, and/or the presence of others.

In one example, the urgency of the communication may be determined in accordance with one or more machine learning models (MLMs) implemented by NF 159. For instance, as referred to herein, a machine learning model (MLM) (or machine learning-based model), may comprise a machine learning algorithm (MLA) that has been “trained” or configured in accordance with input data (e.g., training data) to perform a particular service, e.g., to output an urgency level for a communication, to output a detection of an emergency scenario, or the like. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, a random forest model, a convolutional neural network (CNN), a recurrent neural network (RNN), a long short-term memory (LSTM) model, a gradient boosted decision tree (GBDT), k-means clustering and/or k-nearest neighbor (KNN) predictive models, a scale-invariant feature transform (SIFT) model or Speeded Up Robust Features (SURF)-based algorithm, and so forth. In one example, the MLA may incorporate reinforcement learning (e.g., using positive and negative examples after deployment as a MLM), and so forth. In one example, an MLM of the present disclosure may be in accordance with a MLA/MLM template from an open source library, such as OpenCV, which may be further enhanced with domain specific training data.

In one example, one or more MLMs of the present disclosure may comprise various speech or other audio detection models, e.g., a feature matching detection algorithm which may be trained from extracted audio features from one or more representative audio samples, such as low-level audio features, including: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth, wherein the output of the model in response to a given input set of audio features is a prediction of whether a particular semantic content is or is not present (e.g., sounds indicative of an urgency level (e.g., “excited,” “stressed,” “content,” “indifferent,” etc.), sounds indicative of an emergency scenario (and/or a particular type of emergency scenario), such as the sound of breaking glass (or not), the sound of gunshots (or not), the sound of an argument/altercation, etc.). For instance, in one example, each audio model may comprise a feature vector representative of a particular sound, or a sequence of sounds.

Likewise, for a video call, one or more MLMs of the present disclosure may be associated with detecting dispositions or other moods, mental states, and/or emotional states from facial images. For instance, such detection models may include eignefaces representing various dispositions or other moods, mental states, and/or emotional states, or similar SIFT or SURF models. For instance, a quantized vector, or set of quantized vectors representing a disposition or other moods, mental states, and/or emotional states in facial images may be encoded using techniques such as principal component analysis (PCA), partial least squares (PLS), sparse coding, vector quantization (VQ), deep neural network encoding, and so forth. Thus, in one example, NF 159 may employ a feature matching detection algorithm such as described above. For instance, in one example, NF 159 may obtain content of a video call/video message, and may calculate the Euclidean distance, Mahalanobis distance measure, or the like between a quantized vector of the facial image data in the content and the feature vector(s) of the detection model(s) to determine if there is a best match (e.g., the shortest distance) or a match over a threshold value.

It should be noted that in one example, an urgency of a communication may be determined via an MLM such as described above, e.g., using recipient context and/or sender context as input vector features to obtain an output comprising an urgency level. In one example, the sender context may include semantic content of the communication, e.g., derived from text, audio, and/or images/video, such as an existence of an emergency situation, a disposition/mood of the sender (e.g., user 182), etc. In one example, the semantic content may comprise an addition input/input(s) features to another MLM for determining an urgency of the communication. For instance, user 182 may have a sad face in a video message, but the speech/audio content may indicate that user 182 is just having a bad day, but is not suffering an emergency that may warrant interrupting the user 181 at one or more devices where user 181 may be present. For example, the based upon all of the sender context and recipient context, the urgency of the communication may be 6 out of 10. However, user 181 may have configured do-not-disturb override settings to allow for interruption/override for urgency of 8 out of 10 or above. It is important to note that in one example, while a do-not-disturb setting may be active on device 111, it may be set by user 181 this way because user 181 is in an online meeting via device 112. However, the override of the do-not-disturb setting may not necessarily result in a presentation of the communication/notification of the communication on device 111, but may “punch-through” to reach the user 181 via device 112, such as forwarding the communication/notification thereof to server(s) 185 to present to the user 181 via device 112, and more specifically via an online collaboration and messaging application thereon.

In one example, NF 159 may select an alternate communication modality to reach user 181 in accordance with a rule set/algorithm. Alternatively, or in addition, in one example, NF 159 may implement one or more additional MLMs to select whether and when to change to a different communication modality, which in one example may further include selecting one or more alternative devices on which to reach or attempt to reach the user 181. For example, an additional MLM of NF 159 may be trained to select an alternate communication modality and/or an alternate device to reach user 181. In one example, NF 159 may invoke this additional MLM when it is determined that user 181 is unavailable via the original communication modality attempted by user 182 via device 121 (e.g., a voice communication or text message). For instance, such an MLM may be trained in accordance with a training data set that may include vectors comprising sender and recipient context, the original communication modality, the alternate communication modality selected, and a success or failure of reaching a user via the alternate communication modality. In another example, a label may indicate whether the recipient is satisfied with the decision of NF 159 to override a do-not-disturb setting or to attempt to reach the recipient via the second modality and/or alternate device.

When processing new, real-time data (e.g., sender and recipient context of user 182 and user 181, respectively) for a communication that fails to reach user 181 via device 111 via an initial communication modality, the output may be a recommendation of the one or more alternative modalities. In one example, the recommendation of the one or more alternative modalities may also include one or more recommended alternative devices to attempt to reach the user 181. It should be noted that in any case, the selection of an alternative communication modality may trigger the translation of the communication from the first modality to the second/alterative modality. For instance, NF 159 may perform a speech-to-text conversion, a text-to-speech conversion, or the like. In addition, as noted above, the communication may be updated by NF 159 to include some or all of the context information (e.g., in the content of the communication for presentation to the user 181 and/or as metadata to enable one or more endpoint devices to further process the communication as appropriate). For instance, NF 159 may attempt to deliver a voice message that failed to reach user 181 at endpoint device 111 as a text-based message to device 112 (e.g., a PC). However, in some cases, the device 112 may still suppress the communication according to one or more rules, agents, etc. in operation on the device 112. Other, further, and additional or alternative aspects of a context-aware communication modality translation and selection system are described in greater detail below in connection with the examples of FIGS. 2 and 3.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, NF 159 may be deployed in service network 130, in access network(s) 110, etc. Similarly, any one or more of server(s) 135 and DB(s) 136 may be distributed at different locations, such as in or connected to access networks 110 and 120, in another service network connected to Internet 160 (e.g., a cloud computing provider), in communication service provider network 150, and so forth. Furthermore, although the foregoing describes reaching user 181 via alternative communication modalities of a PC, as noted above, user 181 may be determined to be available/reachable via a television (e.g., device 113). In such case, NF 159 may present a communication/notification thereof via an overlay within a visual content/video stream transmitted from communication service provider network 150 to the TV (device 113). For instance, as noted above, network component(s) 155 may include a broadcast server, a cable head-end, a video-on-demand (VoD) server, and so forth, where the video signals for transmission to device 113 may be personalized to user 181 to include the communication/notification. Likewise, user 181 may alternatively or additionally be determined to be reachable via another cellular-capable/cellular network connected device, such as a smart watch, a cellular-enabled laptop computer, etc. In such examples, NF 159 may determine an availability of user 181 via such devices in accordance with a cellular network-connected status of these devices. Thus, these and other modifications are all contemplated within the scope of the present disclosure.

FIG. 2 illustrates a flowchart of an example method 200 for transmitting a communication obtained in a first modality from a sender device to a recipient device in accordance with a second modality selected based upon a sender device context and a recipient content. In one example, steps, functions, and/or operations of the method 200 may be performed by a device as illustrated in FIG. 1, e.g., NF 159, or the like. In one example, the steps, functions, or operations of method 200 may be performed by a computing device or system 300, and/or a processing system 302 as described in connection with FIG. 3 below. For instance, the computing device 300 may represent at least a portion of a network function for transmitting a communication obtained in a first modality from a sender device to a recipient device in accordance with a second modality selected based upon a sender device context and a recipient content, in accordance with the present disclosure. For illustrative purposes, the method 200 is described in greater detail below in connection with an example performed by a processing system. The method 200 begins in step 205 and proceeds to step 210.

At step 210, the processing system deployed in a communication network, e.g., a cellular network, obtains a communication in a first modality from a sender device to a destination device, where the first modality is one of: a voice communication or a text message. In one example, the destination device may comprise a mobile telephone or other cellular-capable/cellular enable endpoint devices, such as a smartwatch, a laptop or tablet computing device with a SIM card, eSIM, or the like, etc. For instance, the communication may be addressed to the destination device in accordance with an IMSI (e.g., a telephone number) associated with the destination device. In one example, the sender device may also comprise a mobile telephone.

At step 220, the processing system detects a sender device context, the sender device context comprising a location of the sender device. For instance, at a subsequent step of the method 200, an urgency of the communication may be determined based at least in part upon the sender device context. In one particular example, the sender device location may comprise a significant factor in this determination. For example, when a child is calling a parent from a school location at a pickup time, this context may provide a strong indication of urgency. Likewise, a call from a location known to be a hospital may also be urgent if the sender is not known to spend considerable time in hospital settings (e.g., when the sender is not a medical professional or is not involved in a long term treatment of a known chronic condition, this may strongly indicate a possible emergency, etc.). In one example, the sender device context may further comprise an indicator of a mobility status of the sender device, a relationship of the sender to the recipient, and/or a presence of other devices (e.g., devices associated with first responders) in a vicinity of the sender device. In one example, the sender device context may further comprise at least one of: an urgency level of the communication or an emergency scenario (e.g., where the urgency level can be “urgent”/“not urgent,” or can be on a scale such as “junk-unimportant-neutral-important,” 0-5, 1-10, 1-100, 0-100, etc.).

In one example, the urgency level and/or the existence of an emergency scenario may be determined from audio information captured via the sender device, which may be part of the communication content, or which may comprise audio that is not part of the communication itself (e.g., the sender device is transmitting a text message, but audio listening on the sender device is authorized and an emergency scenario is detected local to the device, where this can be a detected “urgency” as part of the sender context). In another example, the urgency level and/or the existence of an emergency scenario may be determined from a text of the communication, e.g., via word/phrase-to-emergency scenario or urgency mapping, via a machine learning model that is trained to output an urgency level based on text message content, etc. To further illustrate, the urgency level and/or the emergency scenario may be detected in accordance with a MLM implemented by the processing system that is trained to detect the urgency level and/or the emergency scenario in response to an input comprising at least one of: the audio information or the text of the communication. For instance, training data for such a model may include text message content and labels of an urgency level. In one example, each labeled record in the training data set may include the text message content and additional sender and/or recipient context. In other words, in one example, the urgency and/or existence of emergency scenario may be based upon the opinions and tolerances of the sender and/or the recipient, and similarly with respect to a MLM for voice/audio communications. In still another example, the processing system may use visual information from a video call/video message using visual models for detecting danger, emergency scenarios, user/sender moods, or the like. It should be noted that in one example, the determination of the urgency level and/or emergency scenario may be local to the sender device, where this information may be provided to the processing system by the sender device as part of or in connection with the communication. For instance, the sender device may implement one or more detection models thereon, e.g., lightweight MLMs, etc.

At step 230, the processing system determines a recipient context associated with a recipient of the destination device, the recipient context comprising an unavailability of a recipient via the destination device. For instance, the unavailability of the recipient via the destination device may comprise: the destination device being unattached to the communication network, the destination device being in a do-not-disturb mode (which may include school time, or other similar statuses, which may all be considered to be a do-not-disturb mode), the recipient being active on another device that is not the destination device, and so forth. In various examples, the recipient context may further comprise at least one of: a location of the destination device, an indicator of a mobility status of the destination device (e.g., determining whether to notify at the destination device may depend on whether it is in motion or at rest/not moving), recipient do-not-disturb override settings (e.g., this can include time of day, day of week, or other considerations), a relationship of a sender associated with the recipient, and/or a presence of other devices in a vicinity of the destination device, and so forth.

At step 240, the processing system selects a second modality for a delivery of the communication to the recipient, where the second modality is different from the first modality, and where the selecting is based upon the sender device context and the recipient context. For instance, the second modality may comprise: a different one of a voice communication or a text message, an over-the-top messaging application message (e.g., via Microsoft Teams™, Slack™, Whatsapp™, or the like), or an over-the-top messaging application session (e.g., a voice or video call/conference, etc.). In one example, the selecting of the second modality for the delivery of the communication to the recipient may be in accordance with a machine learning model implemented by the processing system that is trained to output a recommendation of the second modality in response to an input vector comprising at least: the first modality, the sender device context, and the recipient context. In one example, the selecting of the second modality may further include selecting to transmit the communication to the recipient in accordance with the second modality and via one or more of: the destination device or one or more other devices associated with the recipient. In one example, the processing system may determine that one or more other devices where the recipient may be present. In another example, the processing system may select to transmit to multiple devices associated with the recipient via one or more alternate modalities, e.g., without specific confirmation of recipient presence, but to maximize the likelihood of reaching the recipient via multiple devices (and/or via multiple modalities) known to be associated with the recipient. For instance, a user profile of the recipient stored by or accessible to the processing system may list multiple devices (e.g., cellular endpoint devices) and/or personas (e.g., user accounts/user IDs associated with different collaboration and/or messaging services, etc.) associated with recipient and where the recipient may be reached.

In one example, the selecting to transmit the communication to the recipient via the one or more of: the destination device or the one or more other devices associated with the recipient may be in accordance with a machine learning model implemented by the processing system that is trained to output a recommendation of the one or more of: the destination device or the one or more other devices associated with the recipient in response to an input vector comprising: the first modality, the sender device context, and the recipient context. In one example, different MLMs may be used to select the second modality and the one or more other communication devices. In another example, an MLM may be trained configured to output both the second modality and the one or more other communication devices to which to direct communication(s) via the second modality.

At optional step 250, the processing system may either (1) convert a text content of the communication to an audio format, when the first modality comprises a text message and the second modality comprises a voice communication, or (2) convert an audio content of the communication to a text format, when the first modality comprises a voice communication and the second modality comprises a text message (or other text-based modality).

At step 260, the processing system transmits the communication to the recipient in accordance with the second modality. For instance, the communication may be transmitted to the recipient via at least one of: the destination device or one or more other devices associated with the recipient, e.g., as selected above at step 240. In one example, the transmitting of the communication to the recipient in accordance with the second modality may further include transmitting at least one aspect of the sender device context to the recipient in accordance with the second modality, such as a notification of the urgency level or emergency scenario, an identification of a type of emergency scenario, a location of the sender device, an indication of the presence of others near the sender device and/or identifications of one or more of such individuals (e.g., if known), etc.

At optional step 270, the processing system may transmit the communication to a public safety answering point (PSAP) or one or more first responder endpoint devices based upon at least one of: the urgency level or the emergency scenario. For instance, the processing system may select a modality for a delivery of the communication and/or a notification of the communication to one or more first responder entities, may make any format conversions to the selected modality, etc. In one example, optional step 270 may be in accordance with a rule set/logic indicating: when to automatically notify one or more public safety entities, which public safety entity or entities to notify, etc. For instance, for an urgency level of 10 out of 10, and/or for certain emergency scenarios, the sender may authorize the communication network to automatically notify public safety entities on behalf of the sender. To illustrate, in an emergency the sender may first contact a close relative, but it is even more beneficial to simultaneously notify one or more public safety entities where time is of the essence.

Following step 260 or optional step 270, the method 200 ends in step 295. It should be noted that method 200 may be expanded to include additional steps, or may be modified to replace steps with different steps, to combine steps, to omit steps, to perform steps in a different order, and so forth. For instance, in one example, the processing system may repeat one or more steps of the method 200, such as steps 210-260 for additional communications to the same or a different recipient, from a same or different sender, etc. In one example, the method 200 may alternatively or additionally include determining that the communication fails to reach the recipient in accordance with the second modality, and selecting a third modality, performing any associated content translation, transmitting via the third modality, etc. In one example, the method 200 may further include training one or more of the machine learning models that may be used in the steps above, such as an alternative modality selection model. In such an example, the method 200 may further include collecting feedback for labeling additional samples and for model retraining. For instance, the labels may indicate success/failure of reaching recipients via alternative communication modalities that are selected. In one example, the method 200 may include obtaining the user preferences/permissions of the recipient. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method 200 can be stored, displayed and/or outputted either on the device executing the method 200, or to another device, as required for a particular application. Furthermore, steps, blocks, functions, or operations in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the examples of the present disclosure.

FIG. 3 depicts a high-level block diagram of a computing device or processing system 300 specifically programmed to perform the functions described herein. For example, any one or more components or devices illustrated in FIG. 1, or described in connection with the example(s) of FIG. 2 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for transmitting a communication obtained in a first modality from a sender device to a recipient device in accordance with a second modality selected based upon a sender device context and a recipient content, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 3, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 3 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for transmitting a communication obtained in a first modality from a sender device to a recipient device in accordance with a second modality selected based upon a sender device context and a recipient content (e.g., a software program comprising computer-executable instructions) can be loaded into memory 304 and executed by hardware processor element 302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for transmitting a communication obtained in a first modality from a sender device to a recipient device in accordance with a second modality selected based upon a sender device context and a recipient content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor deployed in a communication network, a communication in a first modality from a sender device to a destination device, wherein the first modality is one of: a voice communication or a text message;
detecting, by the processing system, a sender device context, the sender device context comprising a location of the sender device;
determining, by the processing system, a recipient context associated with a recipient of the destination device, the recipient context comprising an unavailability of the recipient via the destination device;
selecting, by the processing system, a second modality for a delivery of the communication to the recipient, wherein the second modality is different from the first modality, wherein the selecting is based upon the sender device context and the recipient context; and
transmitting, by the processing system, the communication to the recipient in accordance with the second modality.

2. The method of claim 1, wherein the second modality comprises:
a different one of a voice communication or a text message;
an over-the-top messaging application message; or
an over-the-top messaging application session.

3. The method of claim 2, further comprising:
converting a text content of the communication to an audio format, when the first modality comprises a text message and the second modality comprises a voice communication; or
converting an audio content of the communication to a text format, when the first modality comprises a voice communication and the second modality comprises a text message.

4. The method of claim 1, wherein the communication network comprises a cellular communication network.

5. The method of claim 1, wherein the unavailability of the recipient via the destination device comprises:
the destination device being unattached to the communication network;
the destination device being in a do not disturb mode; or
a detection of the recipient being active on another device that is not the destination device.

6. The method of claim 1, wherein the sender device comprises a mobile telephone.

7. The method of claim 1, wherein the recipient context further comprises at least one of:
a location of the destination device;
an indicator of a mobility status of the destination device;
one or more recipient do not disturb override settings;
a relationship of the sender to the recipient; or
a presence of other devices in a vicinity of the destination device.

8. The method of claim 1, wherein the selecting of the second modality for the delivery of the communication to the recipient is in accordance with a machine learning model implemented by the processing system that is trained to output a recommendation of the second modality in response to an input vector comprising:
the first modality, the sender device context, and the recipient context.

9. The method of claim 1, wherein the communication is transmitted to the recipient via at least one of:
the destination device; or
one or more other devices associated with the recipient.

10. The method of claim 9, wherein the selecting of the second modality further comprises selecting to transmit the communication to the recipient in accordance with the second modality and via one or more of:
the destination device; or
the one or more other devices associated with the recipient.

11. The method of claim 10, wherein the selecting to transmit the communication to the recipient via the one or more of: the destination device or the one or more other devices associated with the recipient is in accordance with a machine learning model implemented by the processing system that is trained to output a recommendation of the one or more of: the destination device or the one or more other devices associated with the recipient in response to an input vector comprising:
the first modality, the sender device context, and the recipient context.

12. The method of claim 1, wherein the destination device comprises a mobile telephone.

13. The method of claim 1, wherein the communication is addressed to the destination device in accordance with an international mobile subscriber identity associated with the destination device.

14. The method of claim 1, wherein the sender device context further comprises:
an indicator of a mobility status of the sender device;
a relationship of the sender associated with the recipient; or
a presence of other devices in a vicinity of the sender device.

15. The method of claim 1, wherein the sender device context further comprises at least one of:
an urgency level of the communication; or
an emergency scenario.

16. The method of claim 15, wherein the at least one of: the urgency level or the emergency scenario is determined from:
audio information captured via the sender device; or
a text of the communication.

17. The method of claim 16, wherein the at least one of: the urgency level or the emergency scenario is detected in accordance with a machine learning model implemented by the processing system that is trained to detect the at least one of: the urgency level or the emergency scenario in response to an input comprising at least one of: the audio information or the text of the communication.

18. The method claim 1, wherein the transmitting of the communication to the recipient in accordance with the second modality further comprises:
transmitting at least one aspect of the sender device context to the recipient in accordance with the second modality.

19. A non-transitory computer-readable medium storing instructions which, when executed by a processing system including at least one deployed in a communication network, cause the processing system to perform operations, the operations comprising:
obtaining a communication in a first modality from a sender device to a destination device, wherein the first modality is one of: a voice communication or a text message;
detecting a sender device context, the sender device context comprising a location of the sender device;
determining a recipient context associated with a recipient of the destination device, the recipient context comprising an unavailability of the recipient via the destination device;
selecting a second modality for a delivery of the communication to the recipient, wherein the second modality is different from the first modality, wherein the selecting is based upon the sender device context and the recipient context; and
transmitting the communication to the recipient in accordance with the second modality.

20. An apparatus comprising:
a processing system including at least one processor of an endpoint device; and
a computer-readable medium storing instructions which, when executed by the processing system when deployed in a communication network, cause the processing system to perform operations, the operations comprising:
obtaining a communication in a first modality from a sender device to a destination device, wherein the first modality is one of: a voice communication or a text message;
detecting a sender device context, the sender device context comprising a location of the sender device;
determining a recipient context associated with a recipient of the destination device, the recipient context comprising an unavailability of the recipient via the destination device;
selecting a second modality for a delivery of the communication to the recipient, wherein the second modality is different from the first modality, wherein the selecting is based upon the sender device context and the recipient context; and
transmitting the communication to the recipient in accordance with the second modality.
